(19) United States
(12) Patent Application Publication
(10) Pub. No.: US 2005/0083340 A1
(43) Pub. Date: Apr. 21, 2005

(54) Bi-scale radiance transfer

(75) Inventors: Peter-Pike J. Sloan, Bellevue, WA (US); John M. Snyder, Redmond, WA (US); Xinguo Liu, Beijing (CN); Heung-Yeung Shum, Bellevue, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/687,098

(22) Filed: Oct. 15, 2003

(51) Int. Cl. G09G 5/00

(52) U.S. Cl. 345/582

(57) ABSTRACT

Computer graphics image rendering techniques render images modeling transfer at two scales. A macro-scale is coarsely sampled over an object's surface, providing global effects like shadows and interreflections cast from an arm onto a body. A meso-scale is finely sampled over a small patch to provide local texture. Low-order spherical harmonics represent low-frequency lighting dependence for both scales. To render, a coefficient vector representing distant source lighting is first transformed at the macro-scale by a matrix at each vertex of a coarse mesh, resulting in vectors representing a spatially-varying hemisphere of lighting incident to the meso-scale. A radiance transfer texture specifies the meso-scale response to each lighting basis component, and a function of a spatial index and a view direction. A dot product of the macro-scale result vector with the vector looked up from the radiance transfer texture performs the correct shading integral. An id map places radiance transfer texture samples from a small patch over the object's surface, so that only two scalars are specified at high spatial resolution.

### COPYRIGHT AUTHORIZATION

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### TECHNICAL FIELD

The present invention relates to computer graphics image rendering techniques, and more particularly relates to lighting and shadowing of a modeled object in the rendered image.

### BACKGROUND

A significant challenge in computer graphics is to model the interaction of light and matter at all relevant scales, from macro-level occlusion and interreflection between large objects down to micro-level quantum and diffraction effects. For efficiency, these scales are traditionally decomposed into geometry, texture and lighting models. See, Kajiya, J., Anisotropic Reflection Models, SIGGRAPH 1985, 15-21. While this decomposition accelerates both Monte Carlo simulation and real-time hardware rendering, a gap in quality remains between the two.

To bridge this gap, recent work precomputes global transport effects in a way that can be exploited by fast graphics hardware. The idea is to tabulate over an object or small patch how source illumination is shadowed and scattered back to the viewer, in other words, radiance transfer as a function of spatial location and view. The result can then be quickly rendered from any viewpoint in a variety of lighting conditions. Current techniques precompute only at a single scale, and so are limited either to coarse or fine effects. See, e.g., Sloan et al., Precomputed Radiance Transfer For Real-Time Rendering In Dynamic, Low-Frequency Lighting Environments, SIGGRAPH 2002, 527-536 [coarse effects]; Ashikhmin et al., Steerable Illumination Textures, ACM Transactions on Graphics, 2(3), 2002 [fine effects]; Heidrich et al., Illuminating Micro Geometry Based On Precomputed Visibility, SIGGRAPH 2000, 455-464 [fine effects]; Liu et al., Synthesizing Bidirectional Texture Functions For Real-World Surfaces, SIGGRAPH 2001, 97-106 [fine effects]; and Tong et al., Synthesis Of Bidirectional Texture Functions On Arbitrary Surfaces, SIGGRAPH 2002, 665-672 [fine effects].

Local Effects

There are various existing methods in computer graphics for representing texture effects, but ignoring global transport. The most general of these is the 6D bidirectional texture function (BTF), which encapsulates appearance that varies spatially and with light and view direction. It was first introduced by Dana et al., Reflectance And Texture Of Real World Surfaces, ACM Transactions on Graphics, 1999, 18(1):1-34, for modeling meso-structure of real-world surfaces.

A densely sampled 6D BTF is too expensive to acquire or use for fast image generation, prompting many to resort to lower dimensional alternatives. Polynomial texture maps (PTMs) lower dimensionality to 4D by storing coefficients of a bi-quadratic polynomial per texel. See, Malzbender et al., Polynomial Texture Maps, SIGGRAPH 2001, 519-528. This can model surface appearance under varying lighting directions, but then must neglect view-dependent effects such as masking, foreshortening (parallax), and non-diffuse reflectance. Ashikhmin et al., Steerable Illumination Textures, ACM Transactions on Graphics, 2(3), 2002, also ignore view-dependence but use a steerable basis for directional lights that allows smoother lighting rotation. By precomputing visibility inside a height field and repeatedly tiling it onto a base geometry, Heidrich et al., Illuminating Micro Geometry Based On Precomputed Visibility, SIGGRAPH 2000, 455-464, simulate the local effects of self shadowing and indirect illumination.

Starting with a sparsely-sampled BTF, a denser sampling can be generated by recovering height fields and applying texture synthesis techniques. See, Liu et al., Synthesizing Bidirectional Texture Functions For Real-World Surfaces, SIGGRAPH 2001, 97-106. Novel BTF textures can also be generated from synthetic height fields. These ideas are extended in Tong et al., Synthesis Of Bidirectional Texture Functions On Arbitrary Surfaces, SIGGRAPH 2002, 665-672, to generate BTFs and map them over arbitrary surfaces. BTF indices are synthesized as per-vertex signal over a fine-scale mesh.

Other methods have been developed to represent fully 6D BTFs for rendering on graphics hardware. Daubert et al., Efficient Cloth Modeling And Rendering, EG Rendering Workshop 2001, approximate a BTF using a product of a spatially-varying function of view times a spatially-varying set of parameters to a simple lighting model. Liu et al., Synthesis And Rendering Of Bidirectional Texture Functions On Arbitrary Surfaces, submitted for publication to IEEE TVCG, November 2002, factor 6D BTFs on arbitrary surfaces into a 4D point appearance function multiplied by a 2D spatial modulation function.

Spatially-varying bi-directional reflectance distribution functions (BRDFs) used for interactive performance typically represent reflectance change over a smooth surface rather than view- and light-dependent effects from texture with “depth.” McCallister et al., Efficient Rendering Of Spatial Bi-Directional Reflectance Distribution Functions, Graphics Hardware 2002, is an example, but unlike other methods discussed so far, it handles general lighting by pre-filtering environment maps to avoid on-the-fly light integration.

Global Effects

Precomputed radiance transfer (PRT) captures shadowing and interreflection of an object onto itself. See, Sloan et al., Precomputed Radiance Transfer For Real-Time Rendering In Dynamic, Low-Frequency Lighting Environments, SIGGRAPH 2002, 527-536. Fast, hardware-accelerated rendering is performed for objects that are diffuse or isotropically glossy (but not highly specular), illuminated by low-frequency lighting that can be changed on-the-fly. Much related work, including previous use of the spherical harmonic (SH) basis in computer graphics and other techniques for representing precomputed appearance, is described in that reference. Kautz et al., Fast, Arbitrary BRDF Shading For Low-Frequency Lighting Using Spherical Harmonics, Eurographics Workshop on Rendering 2002, 291-296, generalizes the idea to surfaces with arbitrary, including anisotropic, BRDFs, and also demonstrated 1D spatial variation of a single BRDF parameter using a 3D texture map.

Macro-Scale (PRT)

More particularly, the macro-scale (PRT) transfer technique models exiting radiance as
B(vₚ)·(MₚL) (1)
where L is an n-vector resulting from projecting source lighting into the SH basis, Mₚ is a nxn transfer matrix, and B is a 2D function producing an n-vector and represents the BRDF. Given a source lighting function l(s) over the sphere sεS (i.e., an environment map around the object), L is computed from a spherical integral yielding the approximation

$${L}_{i} = {\int }_{s ∈ S}^{} l ( s ) {y}_{i} ( s ) ⅆ s , l ( s ) \approx {\sum }_{i = 1}^{n} {L}_{i} {y}_{i} ( s ) \qquad ( 2 )$$

where yᵢ(s) is the i-th SH basis function. If the lighting is low-frequency, a good approximation is obtained using a fifth order SH projection having n=25 basis functions. See, Sloan et al., Precomputed Radiance Transfer For Real-Time Rendering In Dynamic, Low-Frequency Lighting Environments, SIGGRAPH 2002, 527-536.

The right vector in equation (1), MₚL is formed by transforming the lighting vector through the transfer matrix and produces incident radiance at p including self-shadowing and interreflection effects. Mₚ includes a rotation of the lighting from a global coordinate frame into a local frame aligned to the normal and tangent directions at p. See, Kautz et al., Fast, Arbitrary BRDF Shading For Low-Frequency Lighting Using Spherical Harmonics, Eurographics Workshop on Rendering 2002, 291-296. The left vector, B(vₚ), represents the shading response in the view direction vₚ given incident lighting expressed in the SH basis and in the local frame. Dotting these vectors integrates lighting times response over the hemisphere, yielding exiting radiance in the direction vₚ. See, Sloan et al., Precomputed Radiance Transfer For Real-Time Rendering In Dynamic, Low-Frequency Lighting Environments, SIGGRAPH 2002, 527-536.

Though PRT captures global effects, recording it at meso-scale sampling rates is impractical. Transfer matrices were computed at a few tens of thousands of samples (vertices) in Sloan et al., Precomputed Radiance Transfer For Real-Time Rendering In Dynamic, Low-Frequency Lighting Environments, SIGGRAPH 2002, 527-536. At meso-scale sampling rates (˜millions of samples over a surface), the Monte Carlo simulation would take hundreds of CPU hours for a single object. Real-time rendering would also be impossible because of the storage (25×25 matrix at millions of vertices) and computation needed (matrix/vector multiply at each vertex).

Meso-Scale (BTF)

On the other hand, the meso-scale (BTF) rendering technique represents transfer from directional light sources. A 6D BTF models exiting radiance as b(uₚ,vₚ,d) where d is the light direction. For real-time rendering, this is approximated in Liu et al., Synthesis And Rendering Of Bidirectional Texture Functions On Arbitrary Surfaces, submitted for publication to IEEE TVCG, November 2002, using a singular value decomposition as
B(vₚ,d)·M(uₚ) (3)
where B and M are vectors having 6-12 component colors (18-36 total channels). More channels increase approximation accuracy.

This representation easily handles lighting from a single lighting direction d. For large lights, B must be repeatedly evaluated and summed over many directions, becoming impractical for real-time rendering. Spatial modulation via M occurs only at one scale. Though the model is based on a small texture patch which was then synthesized onto an object, recording texture synthesis results still requires a very high-resolution texture map M.

### SUMMARY

Image rendering techniques using bi-scale radiance transfer described herein model radiance transfer at two scales. A macro-scale encompasses coarse, geometry-dependent self-shadowing and interreflection effects of a modeled object onto itself, such as shadows from a bunny's ears onto its back. A meso-scale models finer but still macroscopic structure on the modeled object's surface, such as snake scales or stuccowork.

In one embodiment of the bi-scale radiance transfer image rendering, the macro-scale is precomputed over a given geometric object, via a precomputed radiance transfer (PRT) technique. For example, this PRT can store a transfer matrix at each mesh vertex p that converts source illumination into transferred incident illumination, and so accounts for the object's global shadowing and interreflection onto itself. The meso-scale is precomputed over a small patch to obtain a radiance transfer texture (RTT), which can be a 4D RTT mapped over an object using texture synthesis. At run-time, the transfer matrix at each p is first applied to a source lighting vector to produce transferred radiance at the macro-scale. The resulting vector is then dotted with a vector looked up from the RTT, indexed by a spatial location and view direction, to produce the final shade at p. The result provides view- and light-dependent global illumination effects at both scales.

This bi-scale decomposition achieved via this technique has a number of advantages. It samples each scale at the proper rate. In exemplary experiments, the meso-scale was sampled over the surface roughly two orders of magnitude more highly than the macro-scale. Bi-scale decomposition makes the precomputation practical, since otherwise global transport simulation at meso-scale sampling rates would require enormous computation and storage. It also accelerates run-time performance by performing expensive macro-scale computations at coarser sampling rates and retrieving meso-scale results from a small texture. Finally, it allows libraries of meso-textures (e.g., fabric weaves, animal skins, or wall surfaces) to be applied to different geometries.

The PRT and RTT techniques described herein both parameterize appearance by source lighting. Unlike previous fine-scale approaches, they use a low-order spherical harmonic (SH) basis rather than a directional basis. This allows effects like soft-shadows otherwise prohibited by the cost of integrating over many lighting directions. It also avoids aliasing when light sources move. Rendering is accurate if the lighting and BRDF are low-frequency. The technique thus forms a counterpart to traditional methods handling small (point) light sources.

Accordingly, the image rendering using bi-scale radiance transfer techniques described herein provides a way to simulate and render radiance transfer at both a coarse and fine scale. The RTTs described herein differ from existing bidirectional texture functions (BTFs) by using an SH basis for lights (Cf, Dana et al., Reflectance And Texture Of Real World Surfaces, ACM Transactions on Graphics, 1999, 18(1):1-34; Liu et al., Synthesis And Rendering Of Bidirectional Texture Functions On Arbitrary Surfaces, submitted for publication to IEEE TVCG, November 2002; and Tong et al., Synthesis Of Bidirectional Texture Functions On Arbitrary Surfaces, SIGGRAPH 2002, 665-672). In one embodiment of the bi-scale radiance transfer techniques described herein, the RTT is evaluated using an id map to better leverage texture mapping. Further, this embodiment generalizes PRT by composing its result with a general RTT rather than a BRDF (cf., Sloan et al., Precomputed Radiance Transfer For Real-Time Rendering In Lynamic, Low-Frequency Lighting Environments, SIGGRAPH 2002, 527-536; and Kautz et al., Fast, Arbitrary BRDF Shading For Low-Frequency Lighting Using Spherical Harmonics, Eurographics Workshop on Rendering 2002, 291-296). Image rendering using the bi-scale radiance transfer techniques thus can produce images where fine features shadow and mask each other in a complex, spatially varying way without neglecting large-scale effects on a particular object.

Additional features and advantages of the invention will be made apparent from the following detailed description of embodiments that proceeds with reference to the accompanying drawings.

### BRIEF DESCRIPTION OF THE DRAWINGS

FIG. 1 is a block diagram of a computer graphics software architecture incorporating bi-scale radiance transfer for image rendering.

FIG. 2 is a drawing depicting radiance transfer of lighting at macro- and meso-scales of a modeled object.

FIG. 3 is a flow diagram of a Bi-scale radiance transfer precomputation in the image rendering system of FIG. 1.

FIGS. 4A-E are color photographic images of radiance transfer textures (RTTs) of a weave meso-structure rendered at two different viewpoints and five different lighting conditions.

FIG. 5 is a flow diagram of an ID Map generation process in the image rendering system of FIG. 1.

FIG. 6 is a flow diagram of surface parameterizing in the ID Map generation process of FIG. 5.

FIGS. 7A-D are color photographic images of a surface parameterization and ID map generation for an exemplary 3d modeled object (a bunny), including (A) charts on the 3D model; (B) parameterized chart atlas; (C) id map in texture space; and (D) id map on the 3D model.

FIGS. 8A-B are color photographic images of an exemplary modeled object having a parametrically defined surface whose surface mapping is used to directly map the RTT, rather than via an id map.

FIGS. 9A-C are photographic images of an exemplary rock model, comparing results achieved (A) with no global (macro-scale) transport, (B) with macro-scale shadowing transport, and (C) with interreflection and shadowing transport.

FIGS. 10A-E are color photographic images of different meso-structure RTTs mapped to the same exemplary bunny model, including (A) bin, (B) plaster, (C) holes, (D) stucco, and (E) weave.

FIGS. 11A-B are color photographic images of the exemplary bunny model, comparing results with and without macro-scale transport.

FIGS. 12A-B are color photographic images of a zoomed in view of the exemplary bunny model, comparing results with and without view-dependence (masking) in the meso-scale RTT.

FIG. 13 is a block diagram of a suitable computing environment for implementing the bi-scale radiance transfer image rendering of FIG. 1.

### DETAILED DESCRIPTION

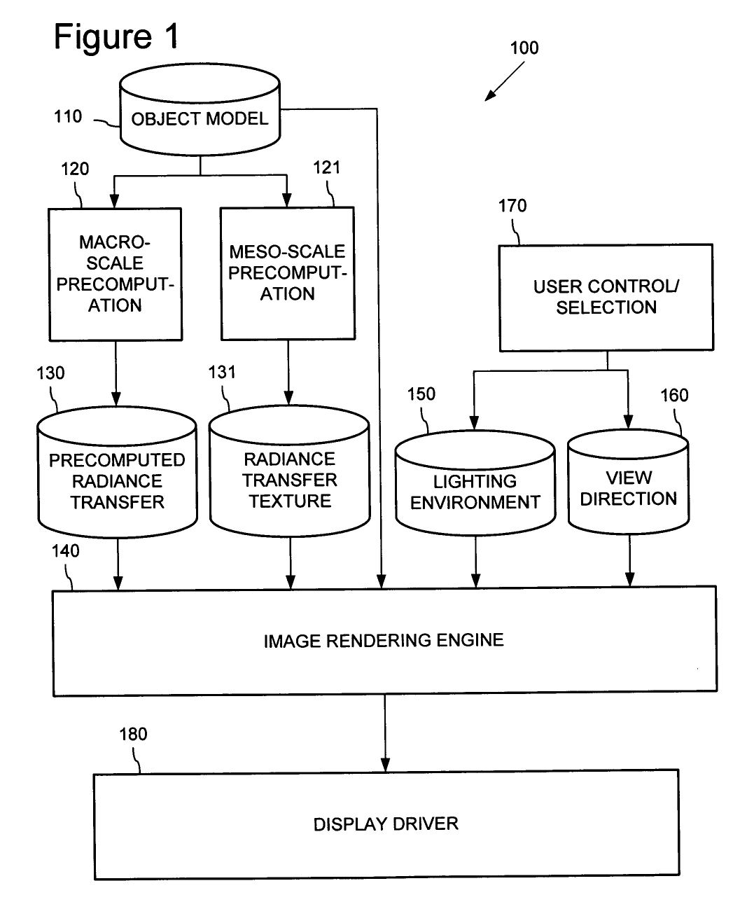

With reference to FIG. 1, a software architecture of a computer graphics image rendering system 100 provides image rendering of a modeled object with a bi-scale radiance transfer image rendering technique described herein. In general, the software architecture includes a macro-scale radiance transfer precomputation 120, a meso-scale radiance transfer texture pre-computation, an image rendering engine 140, and a graphics display driver 180. In the bi-scale radiance transfer rendering technique described more fully below, the macro-scale and meso-scale precomputations 120, 121 perform a pre-processing stage of the technique, which precomputes radiance self-transfer (PRT) data 130 and radiance transfer texture (RTT) data 131 from a geometric object model 110. The geometric model 110 can be a triangulated mesh, wavelet composition, or any other representation of the geometry of the object being modeled, as well as a height field or other model of the meso-scale structure of the object. The image rendering engine 140 then uses the PRT data 130 and RTT 131 data to render images of the modeled object for a dynamically variable lighting environment 150 and viewing direction 160, which can be selectively varied or set with user controls 170. The graphics display driver 180 outputs the images to an image output device (e.g., to a monitor, projector, printer or like).

In some embodiment of the graphics image rendering system, the bi-scale radiance transfer precomputation of simulator 120 and image rendering by the engine 140 can be implemented on a single computer, such as that described in the section entitled, Computing Environment, below. More generally, the simulator 120 can be run on a separate computer, and the resulting data then transferred to the computer on which the rendering engine 140 runs to produce the graphics images.

1. Bi-Scale Radiance Transfer Overview

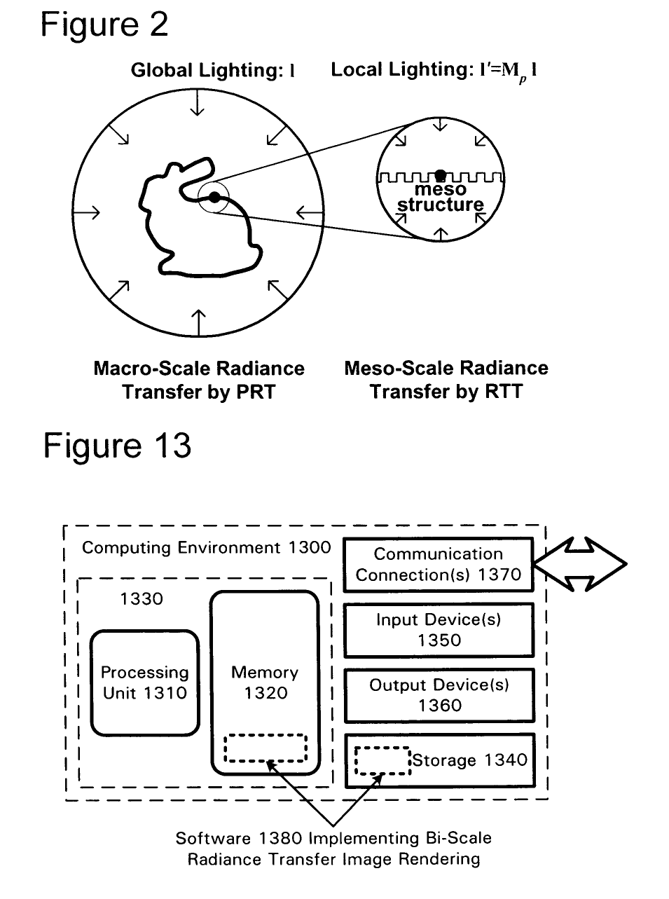

The bi-scale radiance transfer image rendering techniques combine effects of both the macro-scale transfer and meso-scale transfer techniques described in the Background above. In one implementation, the bi-scale radiance transfer combines the effects of these two scales via
B(q(uₚ),vₚ)·(MₚL) (4)
B, Mₚ, and L are defined as for PRT (expressed in equation (1) above), but now B is a 4D function (a radiance transfer texture or RTT) which allows spatial variation as well as view-dependence, as in a BTF. This model first performs coarse shadowing and interreflection via the lighting transformation MₚL, and uses the resulting vector as lighting incident on the meso-scale, represented by B. As illustrated in FIG. 2, this is not just scalar modulation of two separately shaded results from the two scales; the macro-scale produces a spatially-varying radiance function over the entire hemisphere illuminating the meso-scale.

The RTT B specifies the meso-scale appearance of a small patch. Its i-th output channel, Bᵢ(u, v), encodes the response at location u in the direction v to incident lighting expressed using the i-th lighting basis function. Unlike a directional lighting basis, using the SH basis for lighting effectively pre-integrates the lighting response over large, smooth sources. The other novel aspect of this decomposition is the use of q(uₚ), the id map from which B's spatial index is looked up. The id map allows us to place B's samples within triangles of a coarse mesh in a fully general way, via precomputed texture synthesis (described below). Because spatial variation in B is tabulated using relatively few (e.g., 64×64, or 128×128) samples, each of which is a 25D function of the view vector vₚ, it becomes practical for graphics hardware to accelerate rendering using dependent textures. This is much more efficient than rendering a finely-sampled mesh (Cf., Tong et al., Synthesis Of Bidirectional Texture Functions On Arbitrary Surfaces, SIGGRAPH 2002, 665-672).

Spatial variation in the bi-scale model occurs in two places: at a coarse scale in Mₚ, and at a fine scale via B's spatial index q(uₚ). The id map, q, contains only two 25 output channels (two coordinates indexing the RTT). This should be compared to the 36 channels of the meso-scale map M from Formula (3), since both q and M are specified at high (meso-scale) spatial resolution. Moreover, it is unclear how to extend M in Formula (3) to include macro-scale effects, but it is likely even more channels would be required.

2. Precomputing Bi-Scale Radiance Transfer

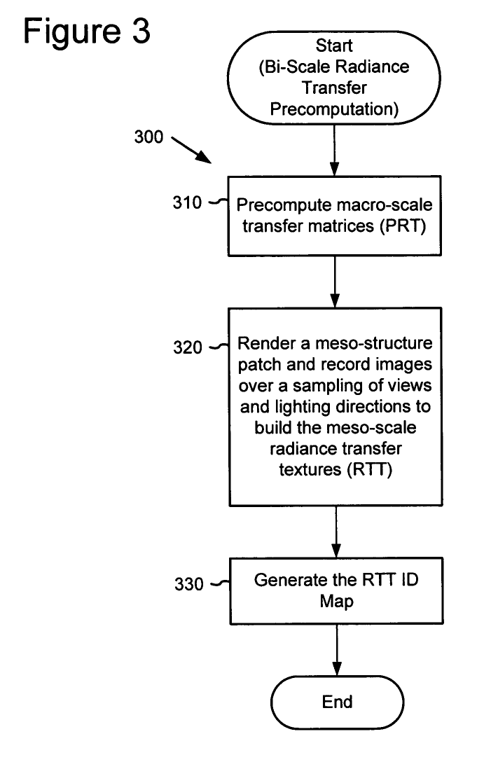

FIG. 3 shows a process 300 to precompute the bi-scale radiance transfer at locations on the surface of the modeled object.

A. Precomputing Macro-Scale Transfer Matrices

At 310 (FIG. 3), the macro-scale precomputation 120 (FIG. 1) precompute the transfer matrices at each mesh vertex, using the Monte Carlo simulation as described in Sloan et al., U.S. patent application Ser. No. 10/389,553 entitled, “Graphics Image Rendering With Radiance Self-Transfer For Low-Frequency Lighting Environments,” filed Mar. 14, 2003, and published as Publication No. US-2003-0179197-A1, the disclosure of which is hereby incorporated herein by reference. Essentially, this illuminates the geometry with source lighting at infinity represented using each of the SH basis functions, and gathers the resulting transferred radiance. The resulting transfer matrices capture self-shadowing and self-interreflection but interreflections are only correct for lighting at infinity.

B. Building the RTT

At 320 (FIG. 3), the meso-scale precomputation 121 (FIG. 1) builds the radiance transfer textures (RTT). Each spatial sample of the RTT linearly transforms source illumination into view-dependent exiting radiance. The spatial variation of this transformation is tabulated over a small patch. In one implementation, this RTT uses a low-order SH basis for lighting, yielding n=25 output channels for each view direction and spatial location.

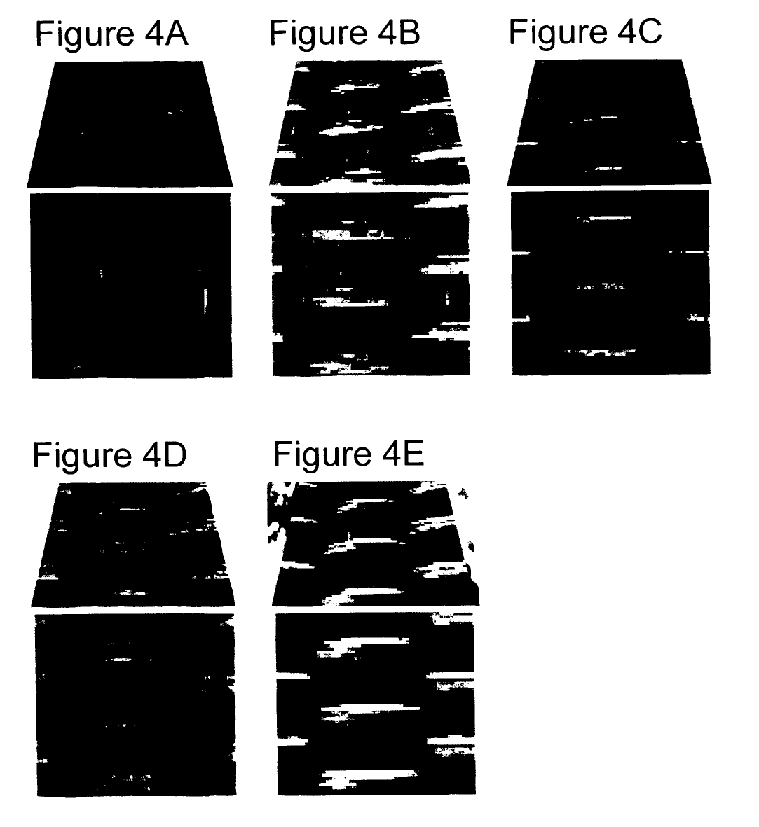

FIGS. 4A-E show such RTTs built for a weave meso-structure patch, where the weave RTT is mapped to a simple square and rendered at two different viewpoints and 5 different lighting conditions. FIGS. 4A and B are RTTs rendered at two viewpoints each under a first light source at 0° and 110°. FIGS. 4C and D are RTTs rendered at the two viewpoints each under a second light source also at 0° and 110°. FIG. 4E are RTTs rendered at the two viewpoints under a lighting environment. Note how the patch responds to area lighting and exhibits view-dependent appearance effects.

The meso-scale precomputation 121 thus generates B by rendering a small patch and recording images over a sampling of views and lighting directions. In some implementations, each channel Bᵢ(uₚ,vₚ) can be obtained by illuminating the geometry using the SH basis function yᵢ(s) as a light source (noting that this is a nonphysical emitter of both positive and negative light). In one implementation, the meso-scale precomputation 121 computes B by rendering using a number of directional light sources, lₖ=(θₖ,φₖ), k=1,2, . . . , nlights, sampling the hemisphere at 8 polar and 16 azimuthal directions. For a given view direction vₚ, each Bᵢ is then obtained by a weighted combination of the resulting nlights=8×16 images, I_{k,vp}(uₚ). Each weight is the product of an SH basis function, yᵢ(lₖ), times the solid angle, da(lₖ), evaluated at the direction sample lₖ, yielding

$${B}_{i} ( {u}_{p} , {v}_{p} ) = {\sum }_{k = 1}^{nlights} {I}_{k , {v}_{p}} ( {u}_{p} ) {y}_{i} ( {l}_{k} ) da ( {l}_{k} ) \qquad ( 5 )$$

To produce the images I_{k,vp}, the precomputation 121 supersamples across the 2D spatial parameter uₚ and decimates using a box filter.

This implementation of the precomputation assumes that the patch's depth variation is much smaller than its tangential extent. Thick meso-structure requires a dense sampling of view directions that is impractical for hardware rendering. Given a thin patch, the precomputation samples images along a plane midway between the patch's depth extent, using conventional global illumination algorithms to generate the images for various viewing (vₚ) and lighting (lₖ) directions. For each view direction vₚ, we directly trace rays passing through the sampling points on this sampling plane, in the direction vₚ.

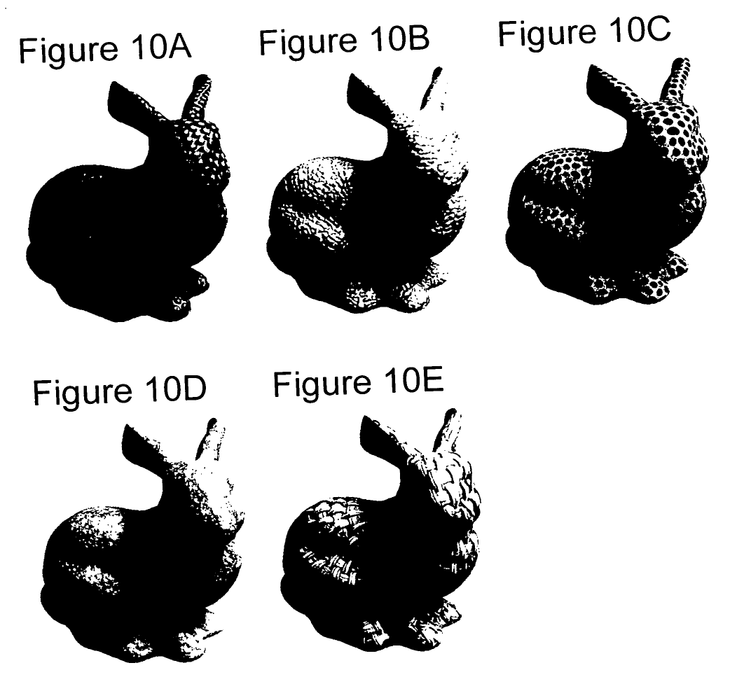

Patch geometry can be modeled as a height field (as described in, e.g., Liu et al., Synthesizing Bidirectional Texture Functions For Real-World Surfaces, SIGGRAPH 2001, 97-106). Color textures can be applied to produce more vivid effects. These height field images can be created in a variety of ways, with various different editing tools. For example, the height field images for the “holes” and “bin” meso-structure samples (used in rendering the images shown in FIGS. 10A and C) were created by an image editing tool; the “stucco” wall sample (FIG. 10D) used a 2D random process. Fully 3D models can also be used: the “weave” example (FIG. 10E) consists of interleaved, deformed cylinders. RTTs can also be acquired rather than generated from synthetic geometry, such as the RTT sample “plaster” (FIG. 10B). Because the initial BTF samples in this data were sparse, a denser sampling was generated using the technique described in Liu et al., Synthesizing Bidirectional Texture Functions For Real-World Surfaces, SIGGRAPH 2001, 97-106. Then, the interpolated BTF data was converted to an RTT via Equation (5), above.

C. Generating the RTT ID Map

At 330 (FIG. 3), the meso-scale precomputation 121 (FIG. 1) generates an RTT ID Map. The RTT id map q(uₚ) maps meso-structure samples onto the macro geometry/surface.

With reference to FIG. 6, a process 500 to generate the id map has the following steps: (510) synthesize meso-scale texture over the 3D surface, (520) parameterize the surface and create a 2D map of its geometry, and (530) for each point in this 2D geometry map, find its RTT id from the synthesized texture.

Synthesizing Meso-Scale Texture Over the Surface: The RTT ID Map generating process 500 at step 510 straightforwardly applies the conventional BTF synthesis algorithm (as described in, e.g., Tong et al., Synthesis Of Bidirectional Texture Functions On Arbitrary Surfaces, SIGGRAPH 2002, 665-672) to the surface. The process first retiles the surface into a dense mesh, call a meso-mesh. Its number of vertices (960 k in our examples) may be comparable to the number of samples in typical textures to allow a high frequency mapping. A conventional texture synthesis algorithm (as described in, e.g., Turk, G., Texture Synthesis on Surfaces, SIGGRAPH 2001, 347-354) is then invoked to synthesize a BTF spatial index at each meso-mesh vertex. Recall that the RTT is derived from the BTF by projecting its directional lighting samples to the SH basis via numerical integration (Equation (5)). Since both maps represent appearance of the same patch (only the lighting basis changes), the spatial index of the BTF can be used on the RTT.

To use graphics hardware efficiently, we parameterize the surface to convert the finely-sampled, per-vertex signal on this meso-mesh into a 2D texture.

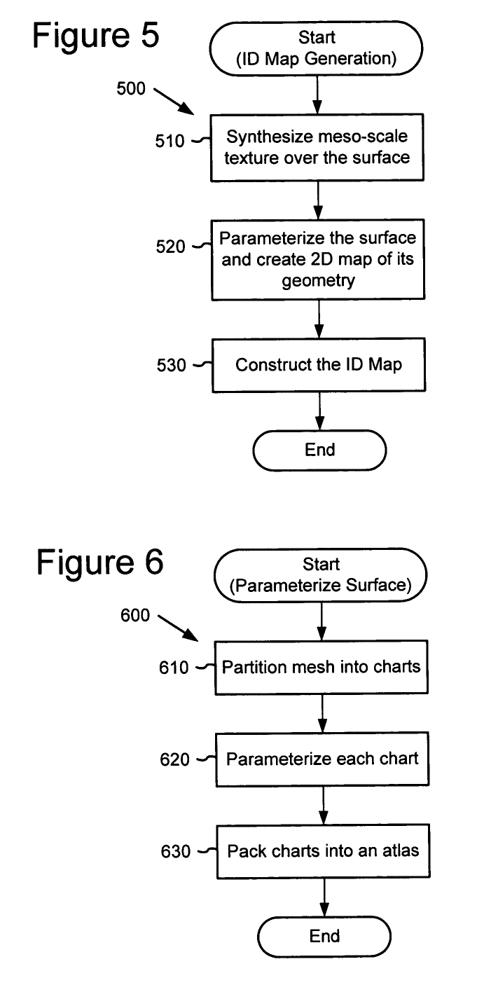

Parameterizing the Surface: With reference now to FIG. 6, the step 520 (FIG. 5) of parameterizing the surface in the RTT ID Map generation process 500 is done in three steps. The first step 610 partitions the mesh into charts, the second 620 parameterizes each chart, and the third 630 packs charts together into a single atlas.

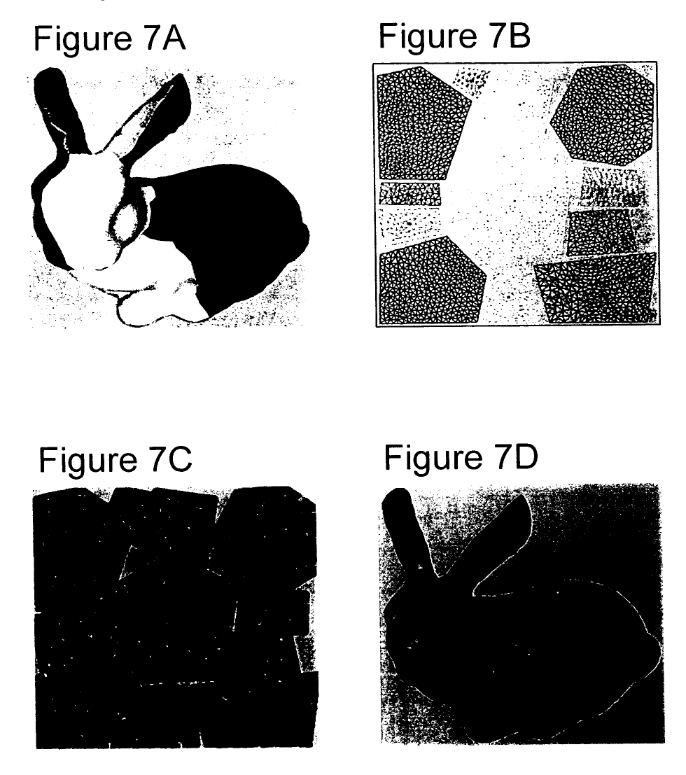

To create charts at 610, the user manually chooses cutting paths dividing the surface of the modeled object into charts using a simple UI. For example, the bunny model is cut into plural charts shown in FIG. 7A. A user-specified number of 3D points along each chart's boundary are chosen as corner points, pᵢ, which map to 2D vertices of the chart's parameterization polygon, vᵢ. Initially these points uniformly subdivide the length of the chart's boundary, but they can be modified by the user.

At 620, the surface parameterization process 600 then parameterizes each chart into a convex, 2D polygon whose vertices vᵢlie on a circle, and where distance between consecutive vertices ∥vᵢ-vᵢ₊₁∥ is proportional to path length of the chart boundary between pᵢ and pᵢ₊₁. The interior of each chart is parameterized using the method described in Sander et al., Texture Mapping Progressive Meshes, SIGGRAPH 2001, 409-416.

At 630, the charts are packed into a single atlas. Automatic chart packing is a hard problem, so in a typical implementation of the bi-scale radiance transfer, the user does the chart packing manually. FIG. 7B shows an example of the charts of FIG. 7A packed into an atlas.

The packed patches should not touch; if they do, bilinear reconstruction during rendering blends between charts that aren't neighbors on the mesh. This implementation of the bi-scale radiance transfer therefore reserves a one texel space around each texture polygon and dilates the texture to this “gutter” space.

Constructing the ID Map: With reference again to FIG. 5, the process step 530 of constructing the ID Map begins by rendering the 3D surface point and normal into each texel of the id map by scan converting the mesh triangles into texture space. This is equivalent to creating a map of the surface geometry including normal. For each id map texel, the process 500 uses “normal shooting” (described in Sander et al., Texture Mapping Progressive Meshes, SIGGRAPH 2001, 409-416) to find its closest meso-mesh vertex. Given a texel with location P and normal N, the process 500 computes this by first finding the k vertices nearest to P in the meso-mesh as candidates. The process 500 selects one of these by comparing distances of each candidate to the line through P along N. This nearest candidates' RTT location (i.e., the 2D coordinate of its associated RTT sample) is recorded into the id map. The ANN tool (described in Mount, ANN programming manual, Dept. Comp. Sci., Univ. of Maryland, College Park, Md., 1998 [accessible via the Internet at http://www.cs.umd.edu/˜mount/ANN/]) can be used to accelerate the k-nearest neighbor query. In one implementation, the parameter value, k=20, is used to allow at least a 2-ring of neighboring vertices assuming an average vertex degree of 6. The example images rendered with bi-scale radiance transfer shown herein (e.g., in FIGS. 10A-E) use id map resolutions of 2048×2048. A visualization of the id map, in texture space and mapped onto the 3D model, appears in FIGS. 7C-D. This is the synthesis result for the “weave” RTT appearing in FIGS. 10A-E.

4. Rendering with Bi-Scale Radiance Transfer

With reference again to FIG. 1, the image rendering engine 140 renders images of the modeled object from the macro-scale precomputed radiance transfer (PRT) data 130 and the meso-scale precomputed radiance transfer texture (RTT) data 131, based on the formula (4) discussed above.

Lighting: In rendering based on the formula (4), the source lighting vector L (the lighting environment data 150) can be computed in various ways, such as those described in Sloan et al., Precomputed Radiance Transfer For Real-Time Rendering In Dynamic, Low-Frequency Lighting Environments, SIGGRAPH 2002, 527-536. The image rendering engine can dynamically rotate a predefined lighting environment 150 about the modeled object to simulate rigid rotations of the object. The image rendering engine can utilize the graphics hardware of the computer on which it is run to sample radiance near the object, which is then SH-projected via Equation (2). The image rendering engine can analytically project simple light sources, such as circles and the like.

Shading: The image rendering engine 140 computes the per-vertex matrix/vector multiplication MₚL of the formula (4) on the CPU since the matrix Mₚ is too large to be manipulated by a vertex shader. The 25D result, representing radiance incident on the meso-scale, is interpolated over triangles by the rasterization hardware. The id map and RTT are accessed using dependent texture mapping, producing another 25D vector B(q(uₚ),vₚ). The two resulting vectors are dotted in a pixel shader.

Accessing the RTT: B is a 4D texture sampled using 64×64 spatial samples (uₚ), and 8×8 view samples (vₚ). The view samples are parameterized over a hemisphere using an area preserving map from the unit square to the hemisphere. (See, Shirley et al., A Low Distortion Map Between Disk And Square, Journal of Graphics Tools, vol. 2, no. 3, 1997, 45-52.)

B's samples are organized as a 2D texture of 8×view blocks. Contiguous view samples allows texture mapping hardware to perform smoother (bilinear) interpolation across views. Interpolation over spatial samples is prohibited, but the RTT is spatially smooth enough to produce good results using nearest-neighbor sampling. Image supersampling improves results.

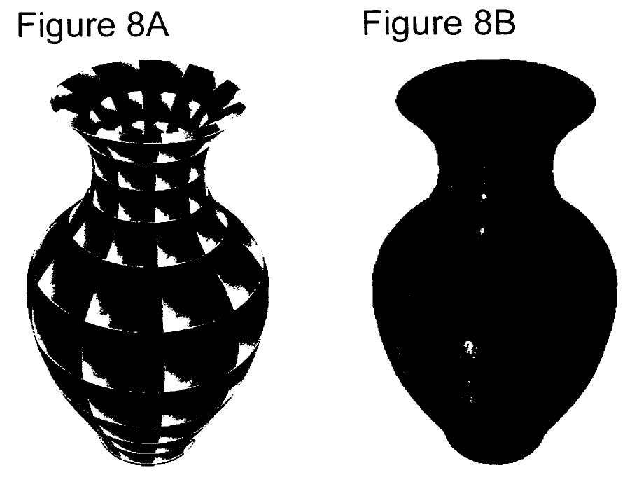

Surfaces defined parametrically already have a mapping (i.e., a up at each vertex) which can be used directly rather than as an index to an id map. This allows only continuous replication of the texture square over the surface and typically causes stretching and shrinking on curved objects. FIGS. 8A-B show a parametric vase example with a trivially mapped “flower” RTT.

Diffuse Special Case: Assuming the local surface is diffuse and neglecting local masking effects, the image rendering engine 140 can eliminate B's dependence on vₚ. This greatly reduces texture memory and bandwidth, and allows higher spatial sampling. Dynamic shadowing and interreflection effects are retained; but shading is constant regardless of view. Even though the local surface is diffuse, we still need a transfer matrix at each point rather than a transfer vector to allow local shadowing and interreflection effects from the RTT.

5. Results

The view-dependent effects of bi-scale rendering can be judged from the example images in FIGS. 4A-E and 12A-B. The RTT mapped to a simple square in FIGS. 4A-E changes appearance as the view changes (oblique view in top image vs. top view in bottom image in each Figure). The structure visible underneath the weave is apparent in the oblique view, while invisible in the head-on view. These effects are even more striking when the RTT is mapped onto a 3D object (FIG. 12A-B). The example image in FIG. 12A is produced with the viewer modified to optionally switch offview-dependence by accessing only the “center” view sample of the RTT rather than indexing via the actual view direction. Note how the texture changes appearance with view angle around the body of the bunny in FIG. 12B, but appears pasted on in FIG. 12A.

FIGS. 4A-D show how the RTT responds to light sources of various sizes and directions. The images in FIGS. 4A and C use the smallest (highest frequency) light source representable by the n=25 SH basis used in this example implementation. The images of FIGS. 4B and D are illuminated from the same directions but use a bigger light source (analytic circle subtending a 110° angle). The shadows are softened, as if the RTT were illuminated on a cloudy day. FIG. 4E uses a spherical lighting environment (“grove”) acquired from high dynamic range imagery, providing a realistic appearance.

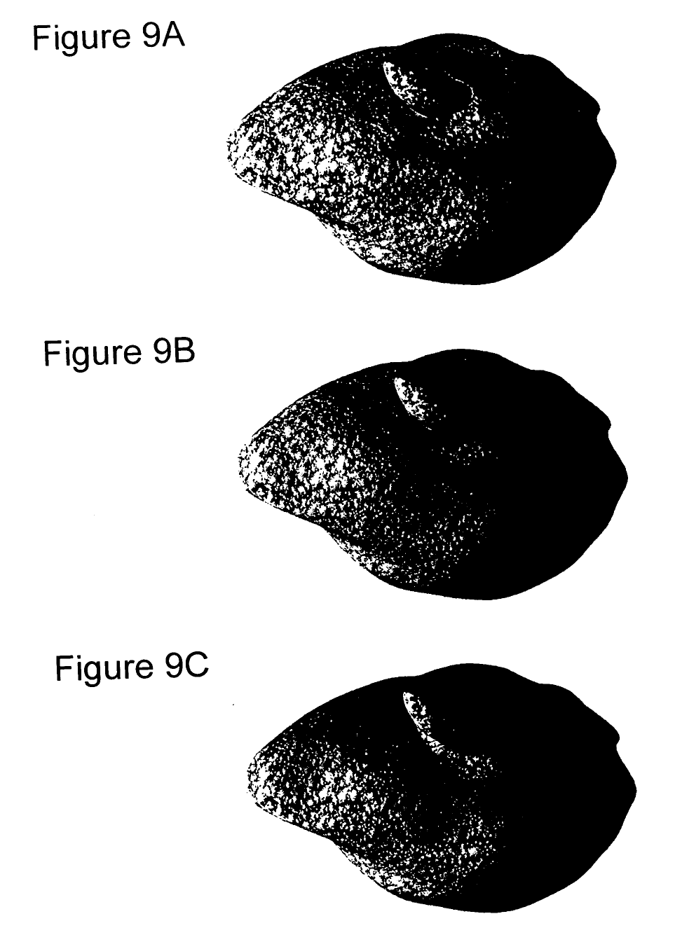

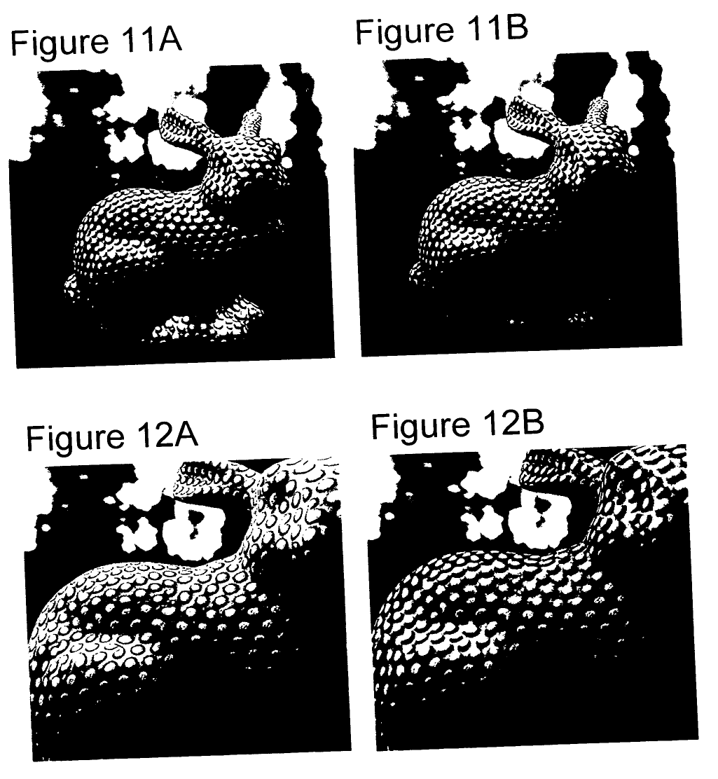

FIGS. 11A-B show how macro-scale transport improves image realism. Without macro-scale shadowing, models exhibit a “glowing” appearance revealing their synthetic nature (FIG. 11A). The macro-scale transport (PRT) fixes these problems (FIG. 11B) making the illusion more complete. FIGS. 9A-C show a similar example using a rock model. FIGS. 9A-C compare results with no global transport (A), shadowing transport (B), and interreflection+shadowing transport (C).

The bi-scale radiance transfer image rendering allows fast manipulation of the view or lighting with proper shadowing and interreflection effects at both scales. In one implementation used to produce the examples shown herein, the bi-scale radiance transfer image rendering achieves a frame rate of ˜14.5 Hz for the birdibunny/rock models with the weave/bin/stucco RTT, rendering to a 512×512 screen window. The macro-scale transfer of the bunny, bird, and rock models was represented using a 25×25 PRT transfer matrix at each of ˜10,800 vertices. View-dependent RTTs (weave, holes, bin) are sampled at 64×64×8×8, while “diffuse” RTTs (plaster, stucco, flower) are sampled at 128×128. Id maps were sampled at 2048×2048. The vase model renders at 35.3 Hz with a transfer matrix at each of 4453 vertices. Timings were conducted on a 2.2 Ghz Pentium IV with ATI Radeon 9700.

Addressing preprocessing costs in the implementation used to produce these examples, meso-structure ray tracing to build the RTT (Section 4.2) requires 0.7-3.0 seconds per image. It is proportional to the meso-mesh complexity, patch size (64×64), and supersampling rate (2×2). A total of 8×16×8×8 images are ray traced over light and view direction. Conversion of the directional lighting basis to the SH basis is fast: about 5-10 minutes. Texton extraction (which precomputes distances between BTF sample pairs for synthesis) ranges from 1-3 hours and is proportional to the patch's spatial size. Texture synthesis requires about 4 hours. Total time to create the bunny+weave samples was about 8 hours. PRT simulation (as described in the section, “A. Precomputing Macro-Scale Transfer Matrices” above) takes about 8 minutes (at ˜10 k vertices) for shadowed transport, and about 17 minutes for the rock example where three further light bounces are simulated.

6. Computing Environment

The above described graphics image rendering system 100 (FIG. 1) that implements the bi-scale radiance transfer image rendering techniques can be implemented on any of a variety of computing devices and environments, including computers of various form factors (personal, workstation, server, handheld, laptop, tablet, or other mobile), distributed computing networks, and Web services, as a few general examples. The graphical user interface with macro expansion display can be implemented in hardware circuitry, as well as in macro processing and viewing software 1380 executing within a computer or other computing environment, such as shown in FIG. 13.

FIG. 13 illustrates a generalized example of a suitable computing environment 1300 in which the described techniques can be implemented. The computing environment 1300 is not intended to suggest any limitation as to scope of use or functionality of the invention, as the present invention may be implemented in diverse general-purpose or special-purpose computing environments.

With reference to FIG. 13, the computing environment 1300 includes at least one processing unit 1310 and memory 1320. In FIG. 13, this most basic configuration 1330 is included within a dashed line. The processing unit 1310 executes computer-executable instructions and may be a real or a virtual processor. In a multi-processing system, multiple processing units execute computer-executable instructions to increase processing power. The memory 1320 may be volatile memory (e.g., registers, cache, RAM), non-volatile memory (e.g., ROM, EEPROM, flash memory, etc.), or some combination of the two. The memory 1320 stores software 1380 implementing the computer graphics image rendering system 100 with bi-scale radiance transfer.

A computing environment may have additional features. For example, the computing environment 1300 includes storage 1340, one or more input devices 1350, one or more output devices 1360, and one or more communication connections 1370. An interconnection mechanism (not shown) such as a bus, controller, or network interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and which can be accessed within the computing environment 1300. The storage 1340 stores instructions for the software 1380 of the computer graphics image rendering system implementing the bi-scale radiance transfer techniques.

The input device(s) 1350 (e.g., for devices operating as a control point in the device connectivity architecture 100) may be a touch input device such as a keyboard, mouse, pen, or trackball, a voice input device, a scanning device, or another device that provides input to the computing environment 1300. For audio, the input device(s) 1350 may be a sound card or similar device that accepts audio input in analog or digital form, or a CD-ROM reader that provides audio samples to the computing environment. The output device(s) 1360 may be a display, printer, speaker, CD-writer, or another device that provides output from the computing environment 1300.

The communication connection(s) 1370 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The bi-scale radiance transfer image rendering techniques herein can be described in the general context of computer-readable media. Computer-readable media are any available media that can be accessed within a computing environment. By way of example, and not limitation, with the computing environment 1300, computer-readable media include memory 1320, storage 1340, communication media, and combinations of any of the above.

The techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “generate,” “adjust,” and “apply” to describe computer operations in a computing environment. These terms are high-level abstractions for operations performed by a computer, and should not be confused with acts performed by a human being. The actual computer operations corresponding to these terms vary depending on implementation.

In view of the many possible embodiments to which the principles of our invention may be applied, we claim as our invention all such embodiments as may come within the scope and spirit of the following claims and equivalents thereto.

1. A computer graphics image rendering method, comprising:
calculating data of macro-scale radiance transfer coarsely sampled over a surface of an object;
calculating data of meso-scale radiance transfer finely sampled over a meso-structure texture patch mapped over a surface of the object;
evaluating radiance transfer over at least a portion of the surface of the object from a lighting environment for a view direction based on a combination of the macro-scale radiance transfer data and the meso-scale radiance transfer data, and
producing an image of the object as lit according to the radiance transfer evaluation.

2. The computer graphics image rendering method of claim 1 wherein the meso-scale radiance transfer data is a height field.

3. The computer graphics image rendering method of claim 1 wherein calculating the meso-scale radiance transfer data comprises:
producing a radiance transfer texture encoding response to incident lighting in a direction and at a location on the meso-structure texture patch and expressed as a lighting basis function; and
producing a spatial index map to map the locations on the meso-structure texture patch onto the surface of the object, via a precomputed texture synthesis.

4. A method of computer rendering of a graphics image of a modeled object in a lighting environment combining macro- and meso-scale effects, comprising:
for a location on a surface of the modeled object viewed from a view direction in the graphics image, determining lighting transferred by the object at the location from the lighting environment as a function of a lighting basis function representation of lighting incident on the object from the lighting environment, a representation on the lighting basis of the radiance transfer of the object's surface sampled at a macro-scale, and a representation on the lighting basis of the radiance transfer of a meso-structure of the object's surface sampled at a meso-scale; and
producing an image of the modeled object in the lighting environment having the location on the modeled object surface lit according to the determined transferred lighting.

5. The method of claim 4 wherein the representation of the radiance transfer of the object's surface sampled at a macro-scale is a pre-computed radiance transfer matrix.

6. The method of claim 4 wherein the representation of the radiance transfer of a meso-structure of the object's surface sampled at a meso-scale is a radiance transfer texture.

7. The method of claim 4 wherein the representation of the radiance transfer of a meso-structure of the object's surface sampled at a meso-scale comprises a radiance transfer texture encoding response at a location on a meso-structure patch in a direction to incident lighting, and a spatial index map mapping from locations on the surface of the modeled object to locations on the meso-structure patch, and wherein the spatial index map operates as an index to the radiance transfer texture.

8. The method of claim 4 wherein the function is B(q(uₚ),vₚ) (MₚL), where B is a radiance transfer texture encoding response at a location on a meso-structure patch in a view direction vₚ to incident lighting and indexed via an id map q(uₚ) that maps locations on the surface of the modeled object to locations on the meso-structure patch, where Mₚ is a precomputed radiance transfer matrix encoding radiance response of the location on the surface of the modeled object to incident lighting L of the lighting environment.

9. Computer-readable data carrying media having encoded thereon computer-executable instructions for performing a computer graphics image rendering method, the method comprising:
calculating data of macro-scale radiance transfer coarsely sampled over a surface of an object;
calculating data of meso-scale radiance transfer finely sampled over a meso-structure texture patch mapped over a surface of the object;
evaluating radiance transfer over at least a portion of the surface of the object from a lighting environment for a view direction based on a combination of the macro-scale radiance transfer data and the meso-scale radiance transfer data, and
producing an image of the object as lit according to the radiance transfer evaluation.

10. The computer-readable data carrying media of claim 9 wherein the global effects comprise self-shadowing and interreflection of the modeled object.

11. A computer system for rendering graphics images of a modeled object, comprising:
a macro-scale lighting simulator operating to perform a lighting simulation of the modeled object to produce a set of macro-scale radiance transfer matrices for a set of macro-scale sampled locations over a surface of the modeled object representing radiance response including global effects to incident lighting at the respective macro-scale sampled locations;
a meso-scale lighting simulator operating to perform a lighting simulation of a meso-structure patch to produce a radiance transfer texture representing radiance transfer of a set of meso-scale sampling locations over a meso-structure patch for a plurality of views and lighting directions;
a texture synthesizer operating to synthesize the meso-structure patch over at least a portion of the modeled object to produce an id map representing a mapping of the meso-structure patch to the portion of the modeled object; and
an image rendering engine operating to determine lighting from a lighting environment for each of a plurality of viewed locations on the modeled object in an image as a function of incident lighting from the lighting environment, the set of macro-scale radiance transfer matrices, and the radiance transfer texture as indexed by the id map; and
a display driver operating to present the image of the modeled object in the lighting environment with the determined lighting.
